(19) United States
(12) Patent Application Publication
(10) Pub. No.: US 2003/0046482 A1
(43) Pub. Date: Mar. 6, 2003

(54) Data management in flash memory

(75) Inventor: Sreekrishnan Venkiteswaran, Kerala (IN)

Correspondence Address: Anthony England, 1717 West Sixth Street, Suite 230, Austin, TX, 78703, US

(73) Assignee: International Business Machines Corporation

(21) Appl. No.: 09/940,708

(22) Filed: Aug. 28, 2001

(51) Int. Cl. G06F 12/00

(52) U.S. Cl. 711/103

(57) ABSTRACT

The described technique emulates a disk drive on flash memory, and avoids storing allocation data structure on flash memory. A device driver is provided for a flash memory device, and the device driver maintains a linked list of sector caches. The use of a list of sector caches enables one to minimize erases and thus flash memory life, as well as speed up write operations to the flash memory device. Heuristics are used to detect the sectors that hold critical meta-data information and give preferential treatment to the corresponding cached sectors. The number of sector caches available to the device driver is configured depending on the memory available in the system.

### FIELD OF THE INVENTION

The invention relates to the use of flash memory as a data storage device and relates particularly though not exclusively to improved techniques of data management using flash memory, especially when the flash memory is accessed from an external operating system for which the flash memory acts as a data storage device.

### BACKGROUND

The contents of a flash memory are updated following a preceding sector erase of the relevant area. Conventional storage mediums do not generally require such erasures. Accordingly, there is a fundamental incompatibility in use of flash memory as a data storage medium with computer systems using conventional operating systems.

One method for storing data on flash memory is disclosed in U.S. Pat. No. 5,404,485 entitled “Flash File System” and issued Apr. 4, 1995 to Ban. In this case, a virtual mapping system is provided that allows data to be continuously written to unwritten physical address locations. The virtual memory map relates flash memory physical location addresses in order to track the location of data in the memory.

While the system disclosed by Ban in U.S. Pat. No. 5,404,485 has certain advantages over previously existing techniques, there are also various limitations associated with these techniques. For example, the described system is relatively complicated to implement. As a virtual memory map is used, the use of standard file-system utilities to debug/repair the stored file-system is precluded. Also, additional data structures need to be stored in the flash memory.

In view of the above, a need clearly exists for a manner of managing data in a flash memory that at least attempts to address one or more of limitations of the prior art.

### SUMMARY

Embedded devices typically have flash memory banks for permanent storage. The proposed technique describes a method for emulating a disk drive on flash memory, thus enabling one or more file-systems to be resident on flash memory.

No allocation data structures need be stored on flash memory. One can upload the embedded flash file-system image to an external host machine and use standard file-system utilities to debug/repair the file-system on the host machine. The described algorithm uses heuristics to detect flash sectors that hold critical meta-data information and gives preferential treatment to the corresponding cached sectors.

The described techniques are implemented as a device driver for a flash memory device. The device driver maintains a linked list of independent sector caches. The use of a list of sector caches enables one to minimize erases and speed up writes to flash memory. Heuristics are used to detect the sectors that hold critical meta-data information and give preferential treatment to the corresponding cached sectors.

The number of sector caches available to the device driver is configured depending on the memory available in the system. A minimum of two sector caches are needed to get reasonable performance. Data is written onto the sector caches, rather than the flash-disk device, and swapped back and forth between the sector caches and flash memory sectors, on demand.

When the flash memory device driver needs to write to a sector of the flash memory, the driver first checks if the sector is already available in the sector cache list. If the sector is already cached in the sector cache list, the write is done onto the corresponding sector cache. If the sector cache is not present in the sector cache list, and if there is a free sector cache available in the cache list, that free sector cache is populated with the desired contents of the corresponding flash memory sector, and the write is done onto this sector cache. If there are no free sector caches available in the list, a sector cache has to be selected to be freed, by swapping the contents of the sector cache back to the appropriate sector of the flash memory.

The algorithm uses heuristics to detect flash sectors that hold critical meta-data information, so that preferential treatment can be given to corresponding sector caches.

The described techniques minimize flash memory erases and writes which slow down flash-disk operations as well as reduce flash memory life.

### DESCRIPTION OF DRAWINGS

FIG. 1 is a schematic representation of a portion of a flash memory.

FIG. 2 is a schematic representation of a partition table for the portion of the flash-disk contents represented in FIG. 1.

FIGS. 3A and 3B jointly represent a flowchart that describes steps involved in writing information to a flash memory using a sector cache.

FIG. 4 schematically represents a sector map array for a sector cache, when stored and represented as a linked list.

FIG. 5 is a representation of the field names of a sector cache information (sc_info) structure.

FIG. 6 is a schematic representation of the components that operate to allow access to a flash memory as a storage medium.

FIG. 7 is a schematic drawing of a computer system which can be used to host the components of FIG. 6.

### DETAILED DESCRIPTION

A method, device driver and computer system are described for providing an advantageous scheme for accessing (reading from and writing to) the contents of a flash memory from a computer operating system. The description below generally describes the operation of an algorithm underlying the operation of the device driver.

A device driver is a computer program that controls a respective device that is attached to a computer. A device driver essentially converts the more general input/output instructions of the operating system installed on the computer to messages that the device can interpret, to allow the device and the operating system to communicate with each other. In this case, a flash memory is a device intended to be attached to a computer, so that a described device driver can be installed in the operating system to allow the flash memory to act as a data storage medium for the computer.

Flash memory is normally organized into banks and further into sectors. Erases of selected portions of the flash memory are performed at the granularity of individual sectors of the flash memory. A flash-write to a location is preceded by a corresponding flash-erase.

The flash-disk device driver maps all the flash banks, into memory that is virtually contiguous, i.e., the banks are mapped adjacent to one another in virtual memory.

The described algorithm is implemented at the device driver level and is transparent to the file-system of the operating system. The algorithm assumes that the embedded operating system uses file-system buffer caching algorithms, such as those generally used by UNIX operating systems. The algorithm is based on caching flash sectors (a cached flash sector is referred to herein as a “sector cache”, in accordance with the meaning given below).

Terminology

In the present specification, the term “flash memory” is used to describe a type of non-volatile memory in which is an electrically erasable and programmable read-only memory (EEPROM) having a programmable operation which allows for the erasure of blocks of memory. Unless there is a clear and express indication to the contrary, any reference to a “flash memory” is taken to include any non-volatile storage memory in which (i) data can be written only in unwritten or erased physical memory locations and in which (ii) a zone of contiguous physical memory locations are simultaneously erased. For ease of reference, storage memory having such characteristics is referred to as “flash memory”.

A brief description of other terminology used herein is given below.

Flash-disk: The area in flash memory that is available for use, to emulate a disk.

Flash-disk driver: The block device driver for the flash-disk. The algorithm described in this discussion is implemented by the flash-disk block driver.

Flash-disk sector: A physical sector in the flash-disk.

Sector cache: A cached copy of a flash-disk sector, maintained by the flash-disk driver. A sector cache can be pinned or unpinned.

Sector cache list: A linked list consisting of the sector caches maintained by the flash-disk driver.

Sector switch: A flash write requires a sector switch, if the previous write was onto another flash sector.

Minor devices: Instances of the flash-disk driver—there is one instance per file-system resident on the flash-disk.

Buffer-cache: A layer of software present in UNIX systems, that reside between the file-system and the device driver. Read and write requests from the buffer-cache to the disk are normally issued in terms of blocks of data.

Sync: An operation that flushes the dirtied blocks in the buffer-cache to the disk. The “sync” (for synchronisation) operation might be done at periodic intervals, but definitely during system shutdown. Writes to the disk may also occur when the buffer cache gets shrunk when the system runs low on memory.

Super-block: The portion of the file-system that contains meta-data information.

Sector caching

The flash memory device driver maintains a linked list of sector caches. The number of sector caches available to the flash memory driver is configured depending on the memory available in the system. A minimum of two sector caches is preferred to enhance performance. Data is written onto the sector caches, rather than the flash-disk device, and swapped back and forth between the sector caches and flash memory sectors, on demand.

When the flash-disk driver needs to write to a flash sector, it first sees if the sector is already available in the sector cache list. If the sector is available, the write is done onto the corresponding sector cache. If the sector is not available, and if there is a free sector available in the cache list, that free sector is populated with the corresponding flash sector contents and the write is done onto this sector cache.

If the sector is not available and there are no free sector caches in the list, a sector cache has to be selected to be freed, by swapping the contents of the selected sector cache back to the flash-disk.

A sector cache that is marked as “pinned”, cannot be swapped back to disk and reused (as described below in the section entitled “Pinning a sector cache”). Among the other sector caches, the cache that has the maximum number of dirty blocks, is selected to be swapped out to the flash-disk. This is because the probability of a sector getting accessed, is inversely proportional to the number of dirty blocks in that sector.

If a block gets written, it generally does not get written again due to the presence of the operating system buffer cache. If the number of dirtied blocks in a sector cache is small, the cache possibly contains other files, or part of a file, that could get written to later. The lesser the number of blocks that have been modified, the greater is the probability that a flash-write is requested again for that sector.

A block in a sector cache is dirty if it is different from what it was, when it was swapped-in from the flash-disk. This can be tracked by using one bit per block of data. All tracking bits are initially reset. Whenever a block is written to, the corresponding bit is set. The number of dirty blocks for a sector cache is incremented, if the block for which the write request is received has not been already marked dirty.

When a sector cache is to be swapped-out to flash-disk, the corresponding sector in the flash-disk is erased and rewritten with the sector cache's contents. The data in the flash-disk sector for which the write request has been received, is then swapped-in to this sector cache.

The sector caches are flushed onto the flash-disk at the end of every “sync” (synchronisation) operation in which the contents of the flash-disk is updated with the contents of the sector caches.

Detecting sectors holding meta-data

Whenever a file gets written to disk, meta-data information for the file is updated in the file-system super-block. The sector(s) containing the super block are usually the most frequently accessed sectors in the flash-disk. The meta-data sectors thus have more number of sector switches (a sector cache write is said to require a sector switch, if the previous write was done onto another sector cache), and the number of modified blocks during each such switch is less (since the space required for meta-data for a file is usually less).

Whenever the number of sector switches to a sector cache reaches a threshold, the count of the number of dirtied blocks for that sector cache is reset to zero. When the threshold is reached, the number of sector switches for the sector cache, is also reset to zero. This means that, this sector cache enjoys an advantage compared to other sector caches for subsequent swap decisions, since a sector cache with a greater number of dirtied blocks is swapped-out first.

If the count of dirtied blocks is reset to zero for a sector cache, the sector cache can remain in the sector cache list, until the dirty block count increases, and exceeds the dirty block count of all other sector caches. Thus, when a sector cache demonstrates the characteristics of a sector cache which holds meta-data information (that is, by having a large number of switches to the sector cache) the sector cache is rewarded with this advantage.

A sector that caches file-system data may have characteristics similar to a sector caching file-system meta-data, if the sector that caches file-system data contains a large number of very small files, many of which have been modified. But such sectors eventually get swapped-out to the flash-disk since only a sector that has continuous and frequent write accesses, and whose number of dirtied blocks are small (like the meta-data sectors) persist in the sector cache list.

The threshold for the number of sector switches, as described above, depends on different factors, such as the following:

1. Average file-size.

2. The probability that another sector shows characteristics similar to that of a super-block. This can happen if a sector holds a large number of very small files, many of which have been modified. This probability increases with size of a flash sector.

3. The probability that another sector cache has more dirtied blocks than the super-block cache(s). If the number of cached sectors is large, the probability that there will be at least one other sector cache with a larger number of dirtied blocks, is higher.

Factor (2) has less likelihood of occurrence. Also if there are more dirtied blocks in another sector (Factor (3)), the effect due to Factor (2) is eliminated, as a sector cache with more number of dirtied blocks is swapped-out first. Assumptions cannot be readily made in relation to Factor (1). Also it is likely that the average file size is more than the size required to store the meta-data for a file. Factor (3) thus has the greatest influence on the calculated threshold.

So, an approximation for the threshold can be given by the mathematical expression (T=K×m) which expresses the mathematic product of K and m, in which T is the threshold for the number of switches to a sector, m is the number of cached sectors and K is a constant numerical value. For smaller values of K, the calculated threshold is more conservative (that is, also smaller). The value of K can be tuned taking into account the size of a sector cache, the average file size (if available), and other relevant factors as appropriate.

Pinning a sector cache

Swapping out sector caches as previously described provides satisfactory performance, but does not guarantee dedicated caching of the critical super-block (meta-data) sectors.

Assuming that the super-block resides in the initial portions of the file-system image, one can guarantee that the sector(s) containing the super-block get erased and written to only once per “sync”, if the corresponding initial sectors are pinned in memory. A pinned sector cache is not available for further swapping. It is permanently dedicated to the flash-disk sector that it is caching.

The size of the meta-data region depends on the particular file system in question. An estimate of the number of initial sectors to pin, is decided based on the following factors:

1. The file-system size.

2. The size of the sectors holding the initial portions of the file-system image.

3. Number of bytes used by the file-system in the first sector, if the file-system does not start on a sector boundary.

A sector cache can be pinned only if there is at least one other non-pinned sector cache (preferably two, if there is at least one other file-system present on the flash-disk that does not have any pinned sectors) available in the sector cache list, for use by other flash-disk sectors.

Multiple file-systems

Multiple file-systems can be accommodated on the flash-disk. The flash-disk driver is able to support multiple devices—one per file-system. That is, multiple flash-disks can be used in conjunction with a suitable computer system. In the terminology of UNIX operating systems, the multiple flash-disks are minor devices. In this case, the sector cache list is global to all minor devices. The minor devices decide to pin sector caches depending on their requirements (refer to the section above entitled “Pinning a sector cache”).

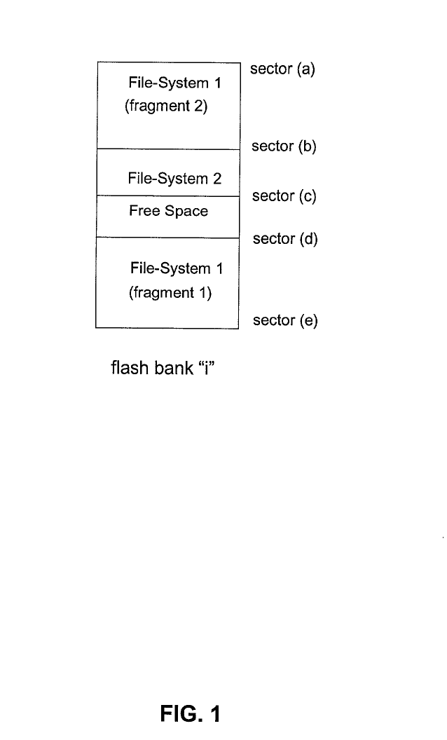

FIG. 1 is a schematic illustration of a portion of a flash-disk, with example contents as represented in FIG. 1. The flash memory comprises a number of banks, one of which (denoted “i”) is represented in FIG. 1. The bank of the flash memory depicted in bank “i” comprises a number of sectors, indicated as sector (a) to sector (d) in this case. As indicated, sectors (a) and (d) contain file-system 1, with sector (a) housing fragment 1 and sector (d) housing fragment 1. Sector (b) houses file-system 2, while sector (c) is free space. FIG. 1 omits the offsets within the sectors, which are not shown for convenience and ease of representation.

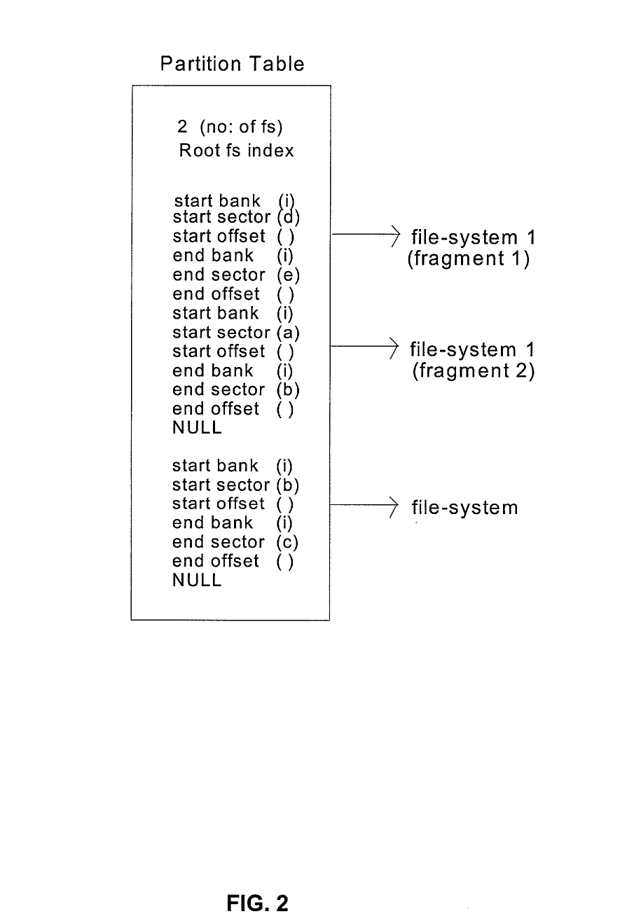

FIG. 2 is a schematic representation of a partition table for the portion of the flash-disk contents represented in FIG. 1. The flash-disk partition information is stored in the partition table, elsewhere on the flash memory. As represented in FIG. 2, the partition area contains a set of null-terminated tuples. Each tuple set has the form: [ (start bank i, start sector i, start offset i), (end bank i, end sector i, end offset i), . . . NULL], and represents different memory fragments on which the corresponding file-system resides. The tuple ordering reflects the fragment ordering. The number of resident file-systems and the index of the root file-system are also part of the partition table, as indicated in FIG. 2. FIG. 2 indicates that for the example given in FIG. 1, the number of resident file-systems is 2.

If multiple file-system fragments are present (as is the case in FIG. 2), the flash-disk device driver has to perform an extra translation on the offsets generated, to locate the correct physical bank, sector and sector offset. The translation to be done is calculated using the fragment tuple information present in the partition table of FIG. 2.

Each minor device reads it's corresponding file-system start address, from the appropriate tuple set in the partition area. The minor device corresponding to the root file-system index, is mounted as the root device when the kernel boots up.

Procedure for flash writes

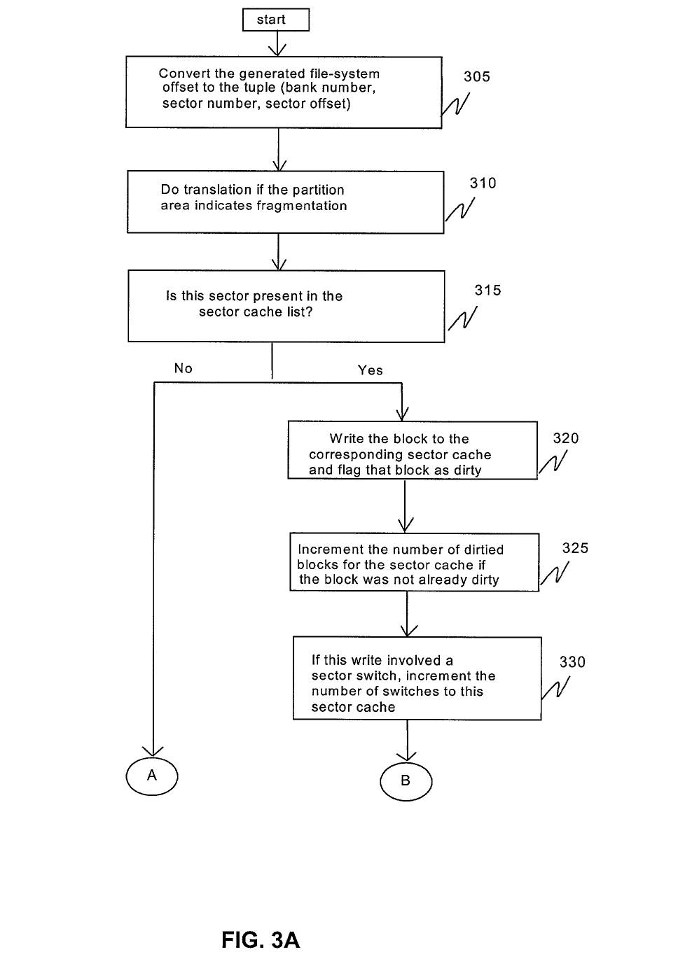

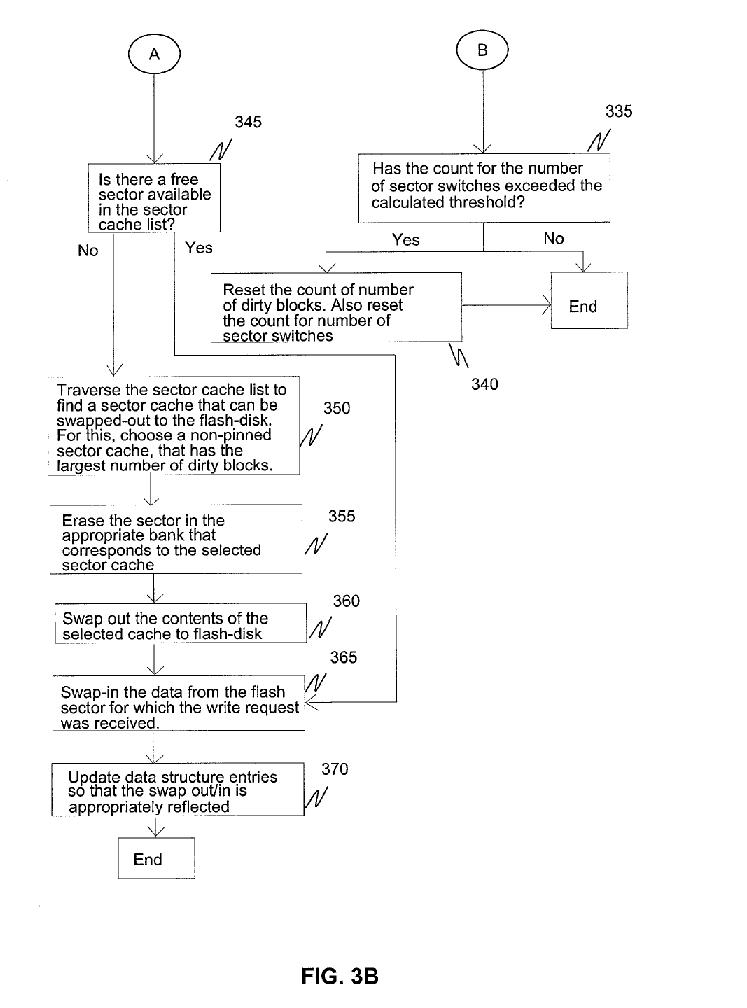

When the flash-disk device driver receives a request to write a block of data (a write request), the driver performs a sequence of steps. These steps, and the algorithm governing these steps in described below with reference to FIGS. 3A and 3B. FIGS. 3A and 3B jointly represent a flowchart that describes the steps for writing to flash-disk using the sector cache list. The write request is serviced as follows:

1. Convert the generated file-system offset, to the tuple (bank number, sector number, sector offset) (step 305). If the file-system image is not contiguous in memory (refer to the section above entitled “Multiple file-systems”), perform the required extra translation (step 310).

2. Check if this sector is in the sector cache list (step 315).

3. If yes (that is, if the checked sector is in the sector cache list),

(a) Write to the corresponding sector cache and flag the corresponding block as dirty (step 320).

(b) Increment the number of dirty blocks for the sector cache, if that block was not already dirty (step 325).

(c) Increment the number of switches to this sector cache, if this write involved a sector switch (step 330).

(d) If the number of sector switches has exceeded the calculated threshold (refer to the section entitled “Detecting sectors holding meta-data”), reset the dirty block count and the number of sector switches for this sector cache (steps 335 and 340).

4. Else,

(a) If there is a free sector cache in the sector cache list, select that sector cache (step 345).

(b) Else,

(1) Traverse the sector cache list to select a sector cache that can be swapped-out to the flash-disk. For this selection, choose a non-pinned sector cache, that has the largest number of dirty blocks (step 350).

(2) Erase the selected sector (in the appropriate bank) that corresponds to the sector cache chosen in the previous step (step 355). (The erase/wait/write commands use the appropriate register locations in the corresponding bank).

(3) Swap-out the contents of the selected sector cache to flash-disk (step 360).

(c) Swap-in the data from the flash sector for which the write request was received, to the selected sector cache (step 365).

(d) Update data structure entries so that the swap out/in is appropriately reflected (step 370). (refer to the section entitled “Implementation” in this respect).

Procedure for flash reads

When the flash-disk driver receives a read request for a block of data, it does the following:

1. Convert the generated file-system offset to the tuple (bank number, sector number, sector offset). If the file-system is not contiguous in memory (refer to the section entitled “Multiple file-systems”), perform the required extra translation.

2. Check if this sector is in the sector cache list.

3. If yes (that is, if the checked sector is in the sector cache list), read the data from the corresponding sector cache.

4. Else, read the data from the corresponding sector in the flash-disk.

The above sequence is as one would expect, and simply operates to access the current (most recent) information recorded in memory, either in the flash memory or the associated cache.

Implementation

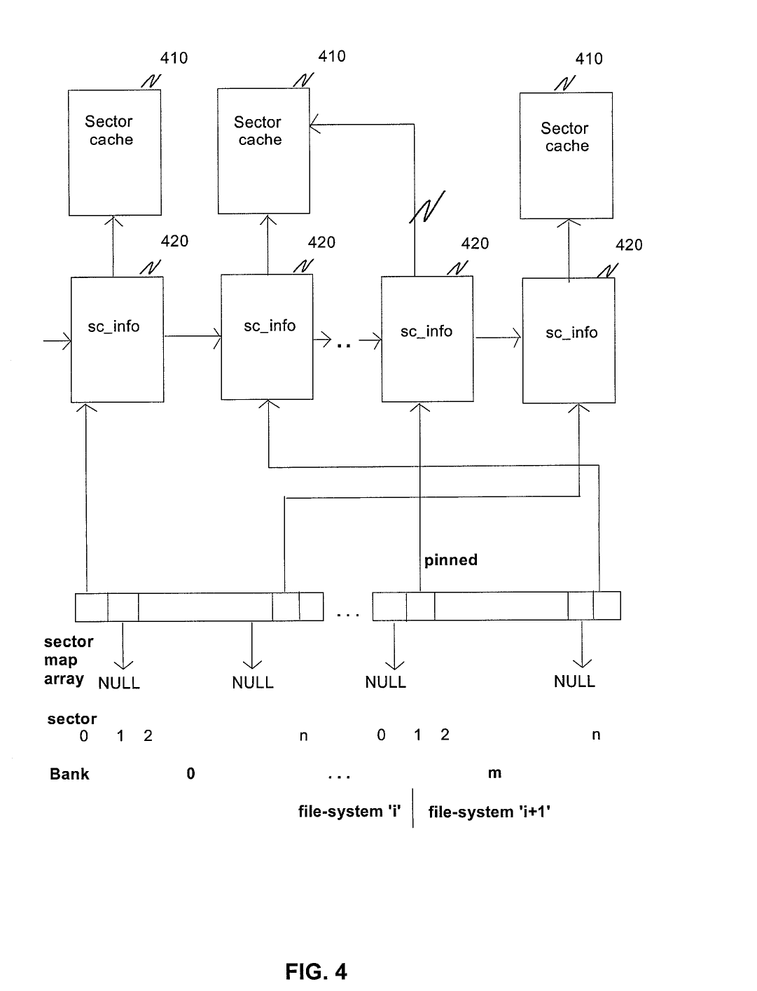

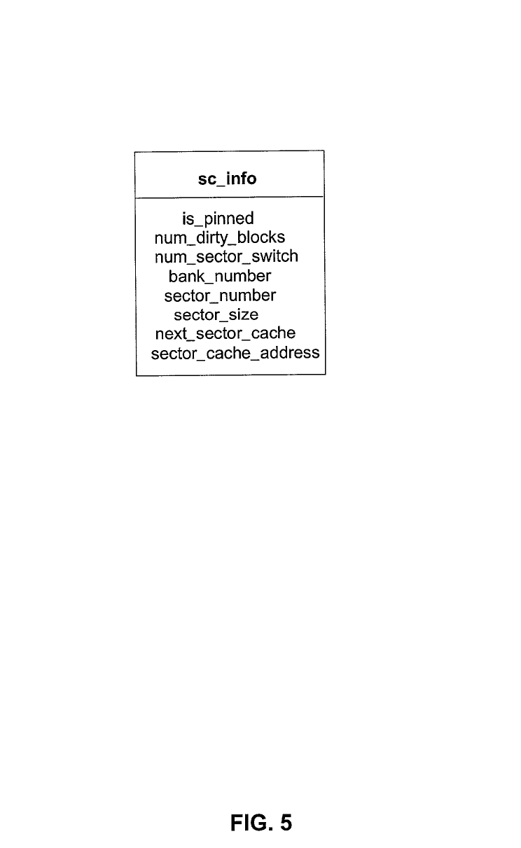

FIG. 4 schematically represents a sector map array for the sector cache, stored and represented as a linked list. Each sector cache 410 has an associated sector cache information (sc_info) structure, which contains the following information listed below. This field of the sector cache information (sc_info) structure 420 is represented in FIG. 4, with the field names represented in FIG. 5. The field names of the sector cache information (sc_info) structure are described in the list below.

1. Whether the associated sector cache is pinned (is_pinned).

2. Number of dirty blocks in the sector cache (num_dirty_blocks).

3. Number of sector switches to this sector cache (num_sector_switch).

4. The corresponding bank number of the flash-disk sector that it is caching (bank_number).

5. The corresponding sector number of the flash-disk sector that it is caching (sector_number).

6. Size of this sector (sector_size).

7. Address of the next sector cache in the list (next_sector_cache).

8. Address of the sector cache (sector_cache_address).

A sector map array is also used, in which each entry (one per sector per bank) points to a sector cache in the above list if it is currently cached, or to NULL if it is not currently cached.

For a write operation to a flash sector, direct indexing is done onto the sector map array, to determine whether it is currently in the sector cache list. If it is (that is, the corresponding entry in the map array is non-NULL), the corresponding sector cache is used for the flash write. Otherwise the sector cache information (sc_info) list is traversed in order to determine whether a free cache entry is available in the list (this is done by checking if a pre-determined invalid value is found in the bank/sector number field of any sc_info element in the list). Also during this traversal, the address of the sc_info element with the largest number of dirtied blocks is found and stored, provided that a free sc_info element has not previously been found. If the sector is not in the cache list and a free sc_info element is available in the list (as determined in the last step), the free entry is populated with the corresponding flash sector's contents and the flash-write is performed onto that sector. If there is no free cache element, the sc_info element with the largest number of dirty words (as determined in the last step) is selected to be swapped back to the flash-disk and thus the freed entry is populated with the corresponding flash-sector and the write is performed onto this sector. The corresponding sc_info element is updated with new values. The corresponding pointers in the map array for the old and new sector, are also updated.

The size of the sector caches in memory is equal to the size of the largest sector in the flash-disk. The memory for the sector caches is allocated during initialization of the flash-disk driver. The number of sector caches in the list can be configured at compile-time of the flash-disk driver, keeping in mind the memory available to the operating system. If the flash memory has variable sized sectors, a sector cache can be shared by more than one smaller sectors.

The described arrangement operates even for one sector cache. In this case, though, preferential treatment cannot be given to sectors holding meta-data information. Accordingly, performance is enhanced by using two or more sector caches, as swap-outs become less frequent.

This algorithm operates satisfactorily under the assumption that the system is shutdown as intended. Under this assumption, further improvements can be effected, like kicking off a thread for the flash-disk sector erase, just after the sector cache is swapped-in (instead of erasing just before a swap-out). If the assumption of regular shutdowns does not hold, periodically flushing dirtied sector caches to the flash-disk adds some robustness. One can also choose to give preferential treatment to the super block (meta-data) sectors (refer to the sections entitled “Detecting sectors holding meta-data” and “Pinning a sector cache”), only during a “sync” and not for any other flash-disk writes that might be requested by the buffer-cache. This again assumes that there is not a system failure for the duration of the “sync”.

Computer hardware and software

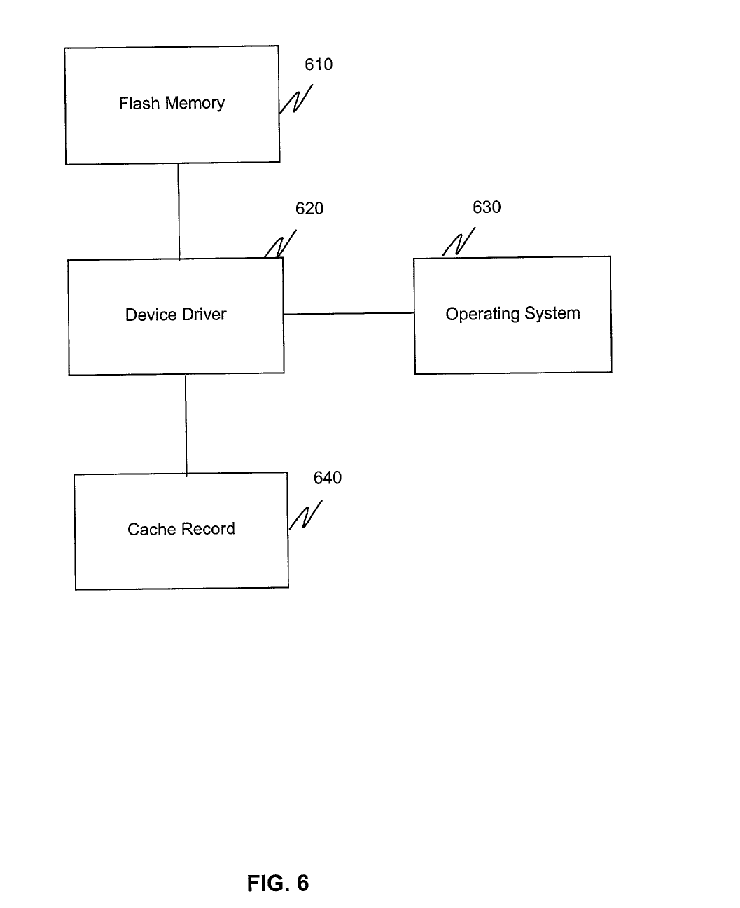

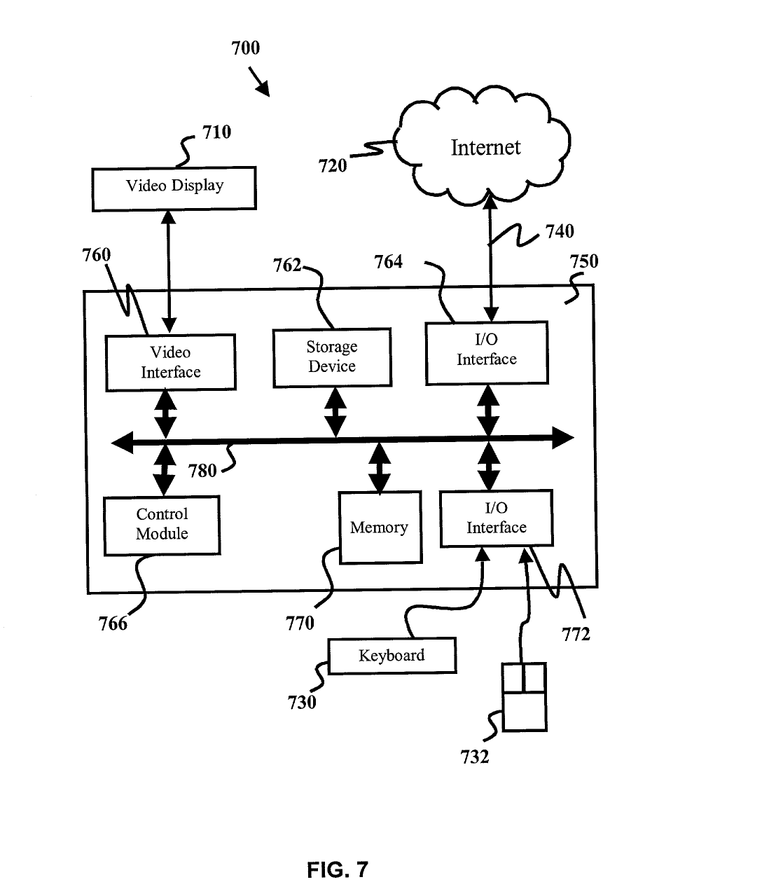

FIGS. 6 and 7 jointly represent aspects of the implementation of the above described techniques and arrangements. FIG. 6 is a schematic representation of the components that operate with the assistance of a host computer system to allow the computer system to be used to access the flash memory 610 as a storage medium. The flash memory 610 interacts with a device driver 620, being software code installed in an operating system 630, to access the flash memory 610. The operating system 630 interacts with both the device driver 620 and an associated sector cache record 640, in the manner described above, in order to interact with the flash memory 610 in the described manner.

The above described technique can be implemented using a device driver 620 in conjunction with an operating system 630 installed and executing on a host computer system 700.

FIG. 7 is a schematic representation of such a host computer system 700. The computer system 700 includes a computer 750, a video display 710, and input devices 730, 732. The computer system 700 can have any of a number of other output devices including line printers, laser printers, plotters, and other reproduction devices connected to the computer 750. The computer system 700 can be connected to one or more other similar computers via a communication input/output (I/O) interface 764 using an appropriate communication channel 740 such as a modem communications path, an electronic network, or the like. The network may include a local area network (LAN), a wide area network (WAN), an Intranet, and/or the Internet 720, as represented.

The computer 750 includes the control module 766, a memory 770 that may include random access memory (RAM) and read-only memory (ROM), input/output (I/O) interfaces 764, 772, a video interface 760, and one or more storage devices generally represented by the storage device 762. The control module 766 is implemented using a central processing unit (CPU) that executes or runs a computer readable software program code that performs a particular function or related set of functions.

Each of the elements in the computer system 750 is typically connected to other devices via a bus 780 that in turn can consist of data, address, and control buses. The video interface 760 is connected to the video display 710 and provides video signals from the computer 750 for display on the video display 710. User input to operate the computer 750 can be provided by one or more of the input devices 730, 732 via the I/O interface 772. For example, a user of the computer 750 can use a keyboard as I/O interface 730 and/or a pointing device such as a mouse as I/O interface 732. The keyboard and the mouse provide input to the computer 750.

The storage device 762 can consist of one or more of the following: a floppy disk, a hard disk drive, a magneto-optical disk drive, CD-ROM, magnetic tape or any other of a number of existing non-volatile storage devices. The flash disk or flash memory 610 is included as a storage device accessed through a respective device driver.

The software may be stored in a computer readable medium, including the storage device 762, or downloaded from a remote location via the interface 764 and communications channel 740 from the Internet 720 or another network location or site. The computer system 700 includes the computer readable medium having such software or program code recorded such that instructions of the software or the program code can be carried out.

The computer system 700 is provided for illustrative purposes and other configurations can be used. The foregoing is merely an example of the types of computers or computer systems with which the described techniques and arrangements may be performed. The driver 620 is resident as a software component (such as an executable file, or dynamic link library). Intermediate storage of the program code of the device driver 620 and any data including entities, tickets, and the like may be accomplished using the memory 770, possibly in conjunction with the storage device 762.

In some instances, the device driver 620 may be supplied encoded on a CD-ROM or a floppy disk (both generally depicted by the storage device 762), or alternatively could be read by the user from the network via a modem device connected to the computer 750. Still further, the computer system 700 can load the device driver from other computer readable media. This may include magnetic tape, a ROM or integrated circuit, a magneto-optical disk, a radio or infra-red transmission channel between the computer and another device, a computer readable card such as a PCMCIA card, and the Internet 720 and Intranets including email transmissions and information recorded on Internet sites and the like. The foregoing are merely examples of relevant computer readable media. Other computer readable media may be used as appropriate.

The device driver 620, as a computer program, includes an expression, in any language, code or notation, of a set of instructions intended to cause a system having an information processing capability to perform a particular function on interacting with a respective associated device, either directly or after either or both of the following: a) conversion to another language, code or notation or b) reproduction in a different material form.

Overview

The described technique relates to an algorithm for emulating a disk, in flash memory. The design aims to minimize erases and writes to the flash. This is a solution at the device driver level and is transparent to the file-system. This technique defines a policy to make use of a list of sector caches to buffer accesses to the flash-disk. The technique implements a procedure that attempts to detect the sectors that hold critical meta-data information, and gives preferential treatment to the cached sectors corresponding to those detected sectors.

While various techniques and arrangements are described in the context of a flash memory, those skilled in the art understand that the described techniques and arrangements relate more broadly to any memory medium similar write, read, and erase characteristics as flash memories. Further, it is understood that various alterations and modifications can be made to the techniques and arrangements disclosed herein, as would be apparent to one skilled in the art.

I claim:

1. A method of maintaining the memory contents of a memory medium having a plurality of memory sectors that are erased before being rewritten, the method comprising the steps of:
maintaining a plurality of independent sector caches each respectively corresponding with a stored memory sector of the memory medium;
writing data to one or more of said sector caches with required changes to the corresponding stored memory sectors of the memory medium; and
accessing the contents of said stored memory sectors from the corresponding sector caches, if said contents are stored in said corresponding sector caches.

2. The method as claimed in claim 1, wherein the sector caches are recorded as a linked list memory structure of said cached memory sectors.

3. The method as claimed in claim 2, wherein the linked list comprises a finite number of said independent sector caches.

4. The method as claimed in claim 3, wherein the contents of each of the stored memory sectors of the memory medium comprises a number of blocks.

5. The method as claimed in claim 4, further including the step of:
maintaining a record, for each of the sector caches, of the number of dirty blocks for which the contents of a sector cache and the corresponding stored memory sector are not currently equivalent.

6. The method as claimed in claim 5, further comprising the step of:
incrementing the recorded number of dirty blocks for a sector cache after performing said step of writing data to the corresponding sector cache in respect of said stored memory sector, if the block for which said step of writing data is performed is not currently marked as dirty.

7. The method as claimed in claim 6, further comprising the step of:
maintaining a record, for each of the sector caches, of the number of sector switches that represent instances in which said step of writing data to the cached memory sectors successively occurs for different sector caches.

8. The method as claimed in claim 7, further comprising the step of:
incrementing the recorded number of sector switches in respect of a sector cache after performing said step of writing data to the sector caches, if said step involved a sector switch.

9. The method as claimed in claim 8, further comprising the step of:
recording a predetermined threshold number of sector switches.

10. The method as claimed in claim 9, further comprising the step of:
resetting the recorded number of sector switches to zero once the recorded number of sector switches exceeds the predetermined threshold number of sector switches.

11. The method as claimed in claim 10, further comprising the step of:
resetting the recorded number of dirty blocks to zero once the recorded number of sector switches exceeds the predetermined threshold number of sector switches.

12. The method as claimed in claim 11, further comprising the step of:
receiving a request to perform a write operation in respect of a stored memory sector.

13. The method as claimed in claim 12, further comprising the step of:
determining whether the stored memory sector subject of said received write request is stored in a sector cache.

14. The method as claimed in claim 13, further comprising the step of:
identifying the sector cache corresponding with the stored memory sector subject of said received write request, if the stored memory sector subject of said received write request is stored in the sector cache.

15. The method as claimed in claim 14, further comprising the step of:
writing to the identified sector cache, in response to said received write request, if the stored memory sector subject of said received write request is stored in the sector cache.

16. The method as claimed in claim 13, further comprising the step of:
determining whether there is an available sector cache not currently associated with a corresponding stored memory sector, if the stored memory sector subject of said received write request is not stored in a corresponding sector cache.

17. The method as claimed in claim 16, wherein if there is not an available sector cache, the method further comprising the steps of:
erasing a selected one of the stored memory sectors of the memory medium; and
writing data from the corresponding sector cache to said selected stored memory sector of the memory medium with the contents of the corresponding sector cache;
wherein the corresponding sector cache becomes available to accept write requests in respect of different stored memory sectors.

18. The method as claimed in claim 17, wherein said selected one of the stored memory sectors is selected on the basis of the corresponding sector cache that has the greatest number of recorded dirty blocks of all the sector caches.

19. The method as claimed in claim 18, further comprising the steps of:
reading the contents of the stored memory sector into the corresponding sector cache; and
writing data to the corresponding sector cache.

20. The method as claimed in claim 1, wherein one or more reserved sector caches sectors persistently correspond with respective stored memory sectors of the memory medium.

21. The method as claimed in claim 20, wherein the reserved sector caches correspond with stored memory sectors in respect of which the step of writing data to the cached memory sectors frequently occurs.

22. The method as claimed in claim 20, wherein the reserved sector caches correspond with stored memory sectors for which critical system meta-data is stored.

23. A method for accessing the memory contents of a memory medium having a plurality of memory sectors that are erased before being rewritten, the method comprising the steps of:
receiving a request to read a stored memory sector of the memory medium;
determining whether the stored memory sector requested to be read is maintained in one of a plurality of independent sector caches each respectively corresponding with a stored memory sector of the memory medium; and
accessing the requested memory sector from one of said plurality of sector caches of the memory medium, if the requested memory sector is maintained in said sector cache.

24. A device driver for a memory medium device having a plurality of memory sectors that are erased before being rewritten, the device driver comprising:
code means for maintaining a plurality of independent sector caches each respectively corresponding with a stored memory sector of the memory medium;
code means for writing data to one or more of said sector caches with required changes to the corresponding stored memory sectors of the memory medium; and
code means for accessing the contents of said stored memory sectors from the corresponding sector caches, if said contents are stored in said corresponding sector caches.

25. A computer system operating under direction of an operating system and having an associated memory medium device having a plurality of memory sectors that are erased before being rewritten, the operating system interacting with the memory medium device via a device driver, the device driver comprising:
code means for maintaining a plurality of independent sector caches each respectively corresponding with a stored memory sector of the memory medium;
code means for writing data to one or more of said sector caches with required changes to the corresponding stored memory sectors of the memory medium; and
code means for accessing the contents of said stored memory sectors from the corresponding sector caches, if said contents are stored in said corresponding sector caches.

26. A device driver for accessing the memory contents of a memory medium having a plurality of memory sectors that are erased before being rewritten, the device driver comprising:
code means for receiving a request to read a stored memory sector of the memory medium;
code means for determining whether the stored memory sector requested to be read is maintained in one of a plurality of independent sector caches each respectively corresponding with a stored memory sector of the memory medium; and
code means for accessing the requested memory sector from one of said plurality of sector caches of the memory medium, if the requested memory sector is maintained in said sector cache.

27. A computer system operating under direction of an operating system and having an associated memory medium device having a plurality of memory sectors that are erased before being rewritten, the operating system interacting with the memory medium device via a device driver, the device driver comprising:
code means for receiving a request to read a stored memory sector of the memory medium;
code means for determining whether the stored memory sector requested to be read is maintained in one of a plurality of independent sector caches each respectively corresponding with a stored memory sector of the memory medium; and
code means for accessing the requested memory sector from one of said plurality of sector caches of the memory medium, if the requested memory sector is maintained in said sector cache.
